(19) United States
(12) Patent Application Publication
(10) Pub. No.: US 2023/0077103 A1
(43) Pub. Date: Mar. 9, 2023

(54) CLOUD SERVER, EDGE SERVER AND METHOD FOR GENERATING INTELLIGENCE MODEL USING THE SAME

(71) Applicant: ELECTRONICS AND TELECOMMUNICATIONS RESEARCH INSTITUTE, Daejeon (KR)

(72) Inventors: Min-Su JANG, Daejeon (KR); Do-Hyung KIM, Daejeon (KR); Jae-Hong KIM, Daejeon (KR); Woo-Han YUN, Daejeon (KR)

(21) Appl. No.: 17/836,087

(22) Filed: Jun. 9, 2022

(30) Foreign Application Priority Data
Aug. 23, 2021 (KR) 10-2021-0111066
May 9, 2022 (KR) 10-2022-0056734

(51) Int. Cl. G06N 20/00; G06K 9/62

(52) U.S. Cl. CPC G06N 20/00; G06K 9/6262; G06K 9/6259

(57) ABSTRACT

Disclosed herein are a cloud server, an edge server, and a method for generating an intelligence model using the same. The method for generating an intelligence model includes receiving, by the edge server, an intelligence model generation request from a user terminal, generating an intelligence model corresponding to the intelligence model generation request, and adjusting the generated intelligence model.

### CROSS REFERENCE TO RELATED APPLICATIONS

This application claims the benefit of Korean Patent Application Nos. 10-2021-0111066, filed Aug. 23, 2021 and 10-2022-0056734, filed May 9, 2022, which are hereby incorporated by reference in their entireties into this application.

### BACKGROUND OF THE INVENTION

### 1. Technical Field

The present invention relates generally to technology for generating, distributing, and managing a machine-learning-based intelligence model.

More particularly, the present invention relates to a method for generating and distributing an intelligence model, which is performed by a cloud server and an edge server.

2. Description of Related Art

In order to effectively implement and execute an Artificial Intelligence (AI) service, it is required to easily secure and apply a high-quality intelligence model that is optimized for the requirements of a terminal and an application environment. Various conventional methods may be used in order to secure and apply an AI model.

First, an expert may perform the overall process of developing an intelligence model. An AI expert acquires a dataset for training an AI model, implements the AI model by selecting or designing the structure thereof, and trains and tests the AI model using the dataset until the operation performance of the AI model reaches a desired level. Then, the resultant intelligence model is installed in an application environment and used.

Here, because all of the processes for securing an intelligence model, such as securing data, developing a program, and training, have to be performed by an expert, securing the AI model requires a high level of difficulty, incurs a lot of expense, and is time-consuming. There is an advantage in that it is possible to secure an intelligence model optimized for an application and an application environment, but the performance and quality of the intelligence model may vary depending on the generation method and the expertise of the person in charge of generating the intelligence model.

Alternatively, an AI expert may select an AI model suitable for the need from among previously released AI models and use the same. That is, a suitable AI model is found through web browsing, and the model and relevant code are acquired and combined with an application, whereby the model is used. This method may be easier and less expensive than the method of manually performing development, training, and data securement, and may also save time.

However, it is difficult to secure a model optimized for an application and an application environment. Because it is required to collect and construct a large amount of data for training/tests in order to secure an optimized model, it takes a lot of time and is expensive. When information about the performance and quality of an intelligence model is available, the quality level may be guaranteed by referring to the information, but when such relevant information is not provided, the performance and quality of the intelligence model cannot be guaranteed.

There is a method in which an AI expert or a general developer uses a cloud-platform-based AI service. Among AI services provided by a cloud platform, an AI service suitable for the need is selected, execution of the AI service is requested using a client-server programming interface provided by the service provider, and a response thereto may be received. As examples of such an AI model service, there are Google Cloud, Microsoft Azure Cognitive Services, Intel Watson, and the like.

This method may reduce the time and cost taken to secure an AI model because it is easy to use. However, because a previously produced AI model is used as service, it is difficult to secure a model optimized for the application to be developed by a user and the application environment. Also, in order to use a cloud platform service, all user data must be transmitted to the cloud platform, which may cause a data security problem.

There is also a method of using a cloud-based intelligence model generation automation service, which has recently emerged. Google's AutoML service trains an intelligence model using training data provided by a user, thereby generating an optimized intelligence model desired by the user and providing the same. This method is less difficult, is inexpensive, and is quickly performed, and also makes it easy to secure a model optimized for an application and an application environment. Because a specialized company generates an intelligence model according to a previously verified process, good performance and quality may be obtained.

However, because it is required to construct and provide a sufficiently large dataset to train an intelligence model, the difficulty level is high, and considerable time and expenses are consumed from the standpoint of data securement. It is impossible to secure an intelligence model if there is no data. Also, because all data is transmitted to a cloud platform in order to train the intelligence model, a data security problem may occur.

### PRIOR ART DOCUMENTS

### Patent Documents

(Patent Document 1) Korean Patent Application Publication No. 10-2020-0052449 entitled “Connected data architecture system to support artificial intelligence service and control method thereof”.

### SUMMARY OF THE INVENTION

An object of the present invention is to provide a method for generating and distributing an intelligence model using a complex computing environment including a cloud server and an edge server.

Another object of the present invention is to quickly secure an intelligence model optimized for an application at low cost.

A further object of the present invention is to generate an intelligence model optimized for an application service and environment even when there is no data or there is only a small amount of data.

Yet another object of the present invention is to prevent data from being exposed outside by dualizing an intelligence model generation process, thereby preventing a security problem and a privacy invasion problem.

In accordance with an aspect of the present invention to accomplish the above objects, there is provided a method for generating an intelligence model, the method being performed by an edge server and a cloud server, the method including receiving, by the edge server, an intelligence model generation request from a user terminal, generating an intelligence model corresponding to the intelligence model generation request, and adjusting the generated intelligence model.

Here, generating the intelligence model may include requesting, by the edge server, the cloud server to generate an intelligence model when failing to generate the intelligence model, and receiving an intelligence model generated by the cloud server.

Here, the cloud server may include a first cloud server and a second cloud server having a capacity greater than a capacity of the first cloud server.

Here, the first cloud server may request the second cloud server to generate an intelligence model when failing to generate the intelligence model.

Here, the intelligence model generation request may include a task identifier, raw data, a comment, a data disclosure scope, and a target label.

Here, generating the intelligence model may include selecting a basic intelligence model based on the intelligence model generation request, modifying a label list of the basic intelligence model to correspond to a target label list, and performing training of the modified intelligence model.

Here, performing training of the modified intelligence model may include performing first training using a previously stored dataset, and performing second training using raw data included in the intelligence model generation request.

Here, requesting the cloud server to generate the intelligence model may include determining raw data to be transmitted to the cloud server based on the data disclosure scope.

Here, adjusting the generated intelligence model may be performed using raw data that is not transmitted to the cloud server.

In accordance with another aspect of the present invention to accomplish the above objects, there is provided an edge server, including a communication unit for performing communication with a user terminal and an additional server, a storage unit for storing data for generating an intelligence model, a model generation unit for generating an intelligence model corresponding to an intelligence model generation request, and an adjustment unit for adjusting the generated intelligence model.

Here, the communication unit requests a cloud server to generate an intelligence model and receives an intelligence model generated by the cloud server when the model generation unit fails to generate the intelligence model.

Here, the cloud server may include a first cloud server and a second cloud server having a capacity greater than a capacity of the first cloud server.

Here, the first cloud server may request the second cloud server to generate an intelligence model when failing to generate the intelligence model.

Here, the intelligence model generation request may include a task identifier, raw data, a comment, a data disclosure scope, and a target label.

Here, the model generation unit may be configured to select a basic intelligence model based on the intelligence model generation request, modify a label list of the basic intelligence model to correspond to a target label list, and perform training of the modified intelligence model.

Here, the communication unit may transmit the raw data to the cloud server based on the data disclosure scope.

Here, the adjustment unit may adjust the intelligence model using raw data that is not transmitted to the cloud server.

In accordance with a further aspect of the present invention to accomplish the above objects, there is provided a cloud server, including a communication unit for receiving an intelligence model generation request from an edge server, a storage unit for storing data for generating an intelligence model, and a model generation unit for generating an intelligence model corresponding to the intelligence model generation request, wherein the intelligence model generation request includes a task identifier, raw data, a comment, a data disclosure scope, and a target label.

Here, the communication unit may request an additional cloud server to generate an intelligence model when the model generation unit fails to generate the intelligence model.

Here, raw data of the intelligence model generation request may be transmitted from the edge server based on the data disclosure scope.

### BRIEF DESCRIPTION OF THE DRAWINGS

The above and other objects, features, and advantages of the present invention will be more clearly understood from the following detailed description taken in conjunction with the accompanying drawings, in which:

FIG. 1 is a flowchart illustrating a method for generating an intelligence model according to an embodiment of the present invention;

FIG. 2 is a flowchart illustrating in more detail a method for generating an intelligence model according to an embodiment of the present invention;

FIG. 3 is a diagram illustrating the configuration of an intelligence model distribution system according to an embodiment of the present invention;

FIG. 4 illustrates an example of an intelligence requirement profile for requesting an intelligence model for image classification;

FIG. 5 illustrates an example of an intelligence requirement profile for requesting an intelligence model for an object detection task;

FIG. 6 illustrates an example of an intelligence requirement profile for requesting an intelligence model for a semantics-based image segmentation task;

FIG. 7 is a block diagram illustrating the structure of an intelligence repository according to an embodiment of the present invention;

FIG. 8 is a diagram illustrating an example of a dataset in a method for generating an intelligence model according to an embodiment of the present invention;

FIG. 9 is a diagram conceptually illustrating the structure of AlexNet;

FIG. 10 is a flowchart illustrating an intelligence model distribution process of the present invention;

FIG. 11 is a flowchart illustrating a process for generating an intelligence model according to an embodiment of the present invention;

FIG. 12 illustrates an example of generation of a standard answer label list;

FIG. 13 illustrates an example of a result of modifying, by an edge server, the intelligence requirement profile of FIG. 4 based on a data disclosure scope;

FIG. 14 is a block diagram illustrating the structure of an edge server according to an embodiment of the present invention;

FIG. 15 is a block diagram illustrating the structure of a cloud server according to an embodiment of the present invention; and

FIG. 16 is a diagram illustrating the configuration of a computer system according to an embodiment.

### DESCRIPTION OF THE PREFERRED EMBODIMENTS

The advantages and features of the present invention and methods for achieving the same will be clarified with reference to embodiments described later in detail together with the accompanying drawings. However, the present invention is capable of being implemented in various forms, and is not limited to the embodiments described later, and these embodiments are provided so that this invention will be thorough and complete and will fully convey the scope of the present invention to those skilled in the art. The present invention should be defined by the scope of the accompanying claims. The same reference numerals are used to designate the same components throughout the specification.

It will be understood that, although the terms “first” and “second” may be used herein to describe various components, these components are not limited by these terms. These terms are only used to distinguish one component from another component. Therefore, it will be apparent that a first component, which will be described below, may alternatively be a second component without departing from the technical spirit of the present invention.

The terms used in the present specification are merely used to describe embodiments, and are not intended to limit the present invention. In the present specification, a singular expression includes the plural sense unless a description to the contrary is specifically made in context. It should be understood that the term “comprises” or “comprising” used in the specification implies that a described component or step is not intended to exclude the possibility that one or more other components or steps will be present or added.

Unless differently defined, all terms used in the present specification can be construed as having the same meanings as terms generally understood by those skilled in the art to which the present invention pertains. Further, terms defined in generally used dictionaries are not to be interpreted as having ideal or excessively formal meanings unless they are definitely defined in the present specification.

Hereinafter, embodiments of the present invention will be described in detail with reference to the accompanying drawings. In the following description of the present invention, the same reference numerals are used to designate the same or similar elements throughout the drawings and repeated descriptions of the same components will be omitted.

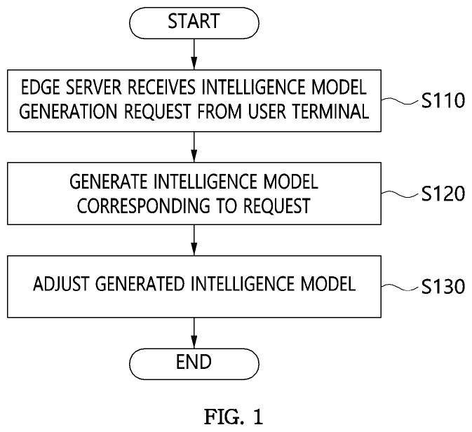

FIG. 1 is a flowchart illustrating a method for generating an intelligence model according to an embodiment of the present invention.

The method of generating and distributing an intelligence model according to an embodiment of the present invention may be performed by an edge server and a cloud server. However, generation of an intelligence model may be performed only by the edge server in response to an intelligence model generation request received from a user terminal, but the scope of the present invention is not limited thereto.

Referring to FIG. 1, the method according to an embodiment includes receiving, by an edge server, an intelligence model generation request from a user terminal at step S110, generating an intelligence model corresponding to the intelligence model generation request at step S120, and adjusting the generated intelligence model at step S130.

Here, step S120 of generating the intelligence model may further include, when the edge server fails to generate an intelligence model, requesting a cloud server to generate the intelligence model and receiving the intelligence model generated by the cloud server.

Here, the cloud server may include a first cloud server and a second cloud server, having a capacity greater than that of the first cloud server.

Here, when it fails to generate an intelligence model, the first cloud server may request the second cloud server to generate the intelligence model.

Here, the intelligence model generation request may include a task identifier, raw data, a comment, a data disclosure scope, and a target label.

Here, step S120 of generating an intelligence model may include selecting a basic intelligence model based on the intelligence model generation request, modifying the label list of the basic intelligence model so as to correspond to a target label list, and performing training of the modified intelligence model.

Here, the step of performing training of the modified intelligence model may include a first training step using a previously stored dataset and a second training step using the raw data included in the intelligence model generation request.

Here, the step of requesting the cloud server to generate an intelligence model may include configuring the raw data to be transmitted to the cloud server based on the data disclosure scope.

Here, step S130 of adjusting the generated intelligence model at step S130 may be performed using raw data that is not transmitted to the cloud server.

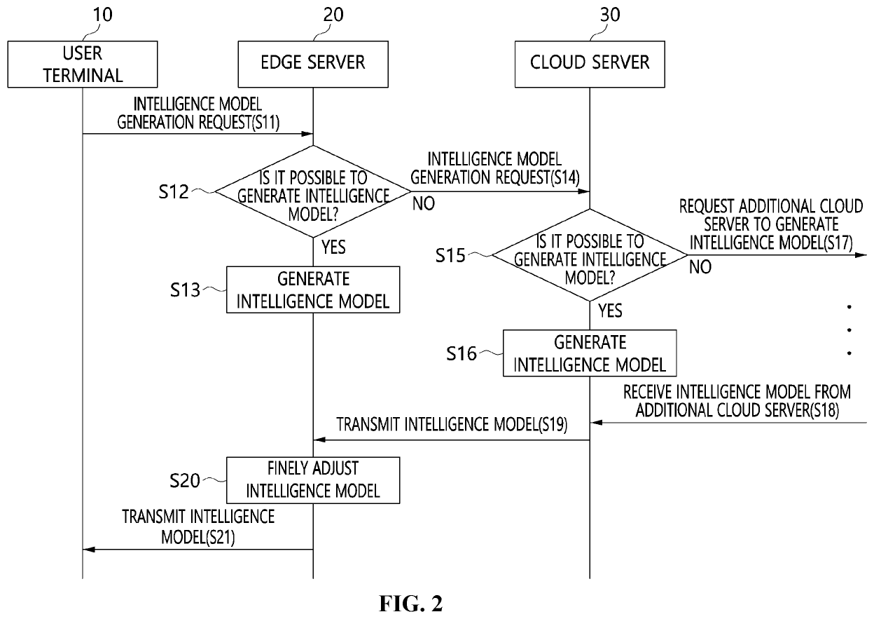

FIG. 2 is a flowchart illustrating in more detail a method for generating an intelligence model according to an embodiment of the present invention.

Referring to FIG. 2, the method for generating an intelligence model according to an embodiment of the present invention may be performed by a user terminal 10, an edge server 20, and a cloud server 30.

The user terminal 10 requests the edge server 20 to generate an intelligence model required for providing a service at step S11. The edge server 20 having received the intelligence model generation request determines whether an intelligence model is capable of being generated in the edge server 20 at step S12. When it is possible to generate an intelligence model at step S12, the edge server generates an intelligence model at step S13, finely adjusts the intelligence model at step S20, and transmits the same to the user terminal 10 at step S21. Here, when the intelligence model is generated in the edge server, step S30 of finely adjusting the intelligence model may be skipped.

When it is impossible to generate an intelligence model at step S12, the edge server 20 delivers the intelligence model generation request to the cloud server 30 at step S14. Here, the term ‘cloud server’ 30 indicates a server having more computing resources than the edge server, but the scope of the present invention is not limited by the term.

The cloud server 30, having received the intelligence model generation request, determines whether an intelligence model is capable of being generated at step S15, and if it is possible to generate an intelligence model, the cloud server 30 generates an intelligence model and transmits the same to the edge server 20. The edge server finely adjusts the received intelligence model at step S20 and transmits the finely adjusted intelligence model to the user terminal 10 at step S21.

When it is impossible to generate an intelligence model in the cloud server at step S15, an intelligence model generation request is made to an additional cloud server at step S17. Here, the additional cloud server may be a server having more computing resources than the cloud server 30. The cloud server 30, having received the intelligence model from the additional cloud server at step S18, transmits the same to the edge server at step S19. The edge server finely adjusts the received intelligence model at step S20 and transmits the finely adjusted intelligence model to the user terminal 10 at step S21.

Here, step S17 of requesting the additional cloud server to generate an intelligence model may be repeatedly or hierarchically performed until a cloud server capable of generating the intelligence model is found. Hereinafter, the present invention will be described in detail through a detailed embodiment.

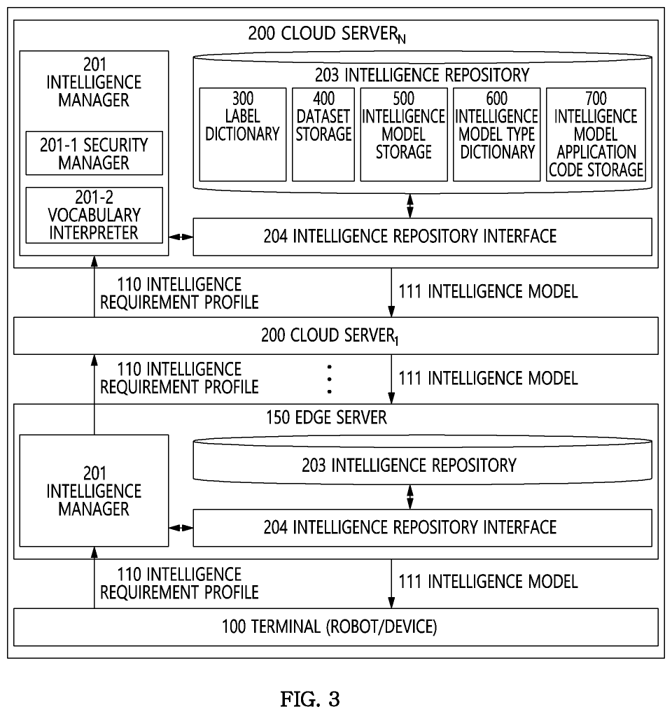

FIG. 3 is a diagram illustrating the configuration of an intelligence model distribution system according to an embodiment of the present invention.

Referring to FIG. 3, the system according to an embodiment of the present invention may include a terminal 100, an edge server 150, and a cloud server 200.

The terminal 100 is a device for providing an intelligent service, such as a robot or a smart speaker, and requests and uses an intelligence model.

The edge server 150 is a computing system connected with the terminal over a network, and is generally located at a place physically close to the location of the terminal. For example, when the terminal is a restaurant service robot, the edge server 150 may be a server computer installed in the restaurant in which the robot is operated.

Unlike a cloud server, the edge server 150 may be used in the zone in which an intelligence model is utilized, e.g., stores such as restaurants, and may be managed by the manager of the corresponding zone. Here, according to a personal information protection law or a rule set by the manager, the edge server 150 separates data allowed to be exposed outside and data to be protected from being exposed, among pieces of data to be provided for generation and use of an intelligence model, and transmits only the data allowed to be exposed outside to an external server, thereby solving a data security problem.

According to the intelligence model generation method of the present invention, the intelligence model generated using publicly available data in a cloud is retrained and optimized using secure data in an edge server, whereby a desired intelligence model may be secured while a data security problem may be solved.

The cloud server 200, which is a computing device operated in a remote site, has more computing resources than terminals or edge servers, and may process requests from multiple edge servers or terminals. According to the present invention, cloud servers may be connected in a hierarchical manner across multiple tiers. When it is impossible to generate and distribute an intelligence model in the cloud server directly connected with the edge server, the request is forwarded to a cloud server in the next tier, and is then processed. Desirably, because a more remotely located cloud server, that is, a cloud server at a higher tier, has a larger repository and a greater amount of computing resources, it may store a greater number of intelligence models and datasets and generate and distribute more extensive intelligence models.

The edge server 150 and the cloud server 200 perform functions of generating and distributing an intelligence model through an intelligence repository 203, an intelligence repository interface 204, and an intelligence manager 201.

The intelligence repository 203 stores and manages information required for generation and optimization of an intelligence model. The information encompasses all of labels for indicating targets to be handled by the intelligence model, a dataset used to train and evaluate the intelligence model, the structure and content of the intelligence model, and a program for performing inference, training, transfer learning, and the like based on the intelligence model.

The intelligence repository interface 204 is a message or programming interface used to store and read all of the above-mentioned information.

The intelligence manager 201 performs functions of generating and distributing an intelligence model, requested by a terminal, an edge server, or a cloud server at a lower tier, using the intelligence repository 203. Here, when the server is not capable of generating an intelligence model by itself, the intelligence manager 201 may deliver the request for the intelligence model to a server at a higher tier and receive the intelligence model distributed by the server.

The intelligence requirement profile 110 is a data structure in which intelligence specifications required by a terminal are recorded, and includes functions to be performed by the intelligence model and data required for training the intelligence model.

In an embodiment of the present invention, transmission of an intelligence model may be implemented by transmitting the generated ‘intelligence model’ along with a ‘program’ capable of executing functions by running the model. The terminal 100 executes the ‘program’ by inputting the received ‘intelligence model’, thereby utilizing the inference function of the generated intelligence model.

Hereinafter, the structure of an intelligence requirement profile 110 according to an embodiment of the present invention will be described in detail.

Generation and distribution of an intelligence model are realized by transmitting an intelligence requirement profile 110. The intelligence requirement profile 110 contains condition information required for generating an intelligence model. In an embodiment of the present invention, the intelligence requirement profile 110 includes a task specification and target data.

The task specification describes the content of a task that has to be performed by the intelligence model, and is used to retrieve and select an intelligence model in an edge server and a cloud server. In an embodiment of the present invention, the task specification includes a task identifier, input information, and output information.

The task identifier is a field indicating the task performed by the intelligence model, and examples of the value thereof may include classification, detection, semantic segmentation, instance segmentation, natural language translation, image captioning, and the like.

The input information describes the format and content of data given as the input of the intelligence model. In an embodiment, the input information may be described based on modalities, such as an image, video, audio, or text.

The output information describes the format and content of output data, which is output by the intelligence model after it receives the input and processes the same. In an embodiment, the output information may be described as a class identifier (Class ID), a bounding box, a pixel-wise image mask, and the like. Table 1 below illustrates some examples of the task specification.

TABLE 1

| Task Identifier | Input | Output | Description |
|---|---|---|---|
| classification | image | class id | Receive an image and classify the same as |
| | | | multiple defined classes |
| detection | image | bounding-box | Receive an image, detect a specific object, and |
| | | | output the coordinates of the area thereof. |
| detection | image | (bounding-box, class id) | Receive an image and output the area of an object |
| | | | and a class ID |
| classification | audio | class id | Receive an audio sample and classify the same as |
| | | | a defined class |
| classification | video | class id | Receive a video clip and classify the same as a |
| | | | defined class |
| semantic | image | (image mask, class id) | Receive an image and output the image mask of |
| segmentation | | | an object area for each specific category |
| captioning | image | sentence | Receive an image and output a sentence |
| | | | describing a scene in the image |
| captioning | video | sentence | Receive video and output a sentence describing a |
| | | | scene in the video |
| auto-encoding | image | image | Perform auto-encoding on an image |

The target data 110-2 is data capable of being used to train or optimize the intelligence model, and includes various forms of raw data 110-3, such as an image, audio, text, and the like, data comments 110-4 indicating information that has to be output by the intelligence model receiving the raw data, the disclosure scope 110-5 of each piece of data, and target answer labels 110-6 indicating the targets that have to be dealt with by the intelligence model although raw data therefor is not provided.

The data comment 110-4 indicates an answer for each entry of the raw data 110-3. The answers may have different forms depending on the type of task to be performed by the intelligence model, such as classification, detection, segmentation, and the like.

The disclosure scope 110-5 represents the scope within which each piece of raw data and a data comment are capable of being disclosed. By limiting the data disclosure scope, the purpose of protecting private information of individuals or companies using the intelligence model may be achieved. In an embodiment, the disclosure scope may be described as ‘local’ or ‘global’. The edge server, having received the intelligence requirement profile, transmits data labeled with ‘global’ to a cloud server, but processes data labeled with ‘local’ autonomously, rather than transmitting the same to the cloud server, thereby protecting data.

The target answer label list 110-6 includes the names of targets to be detected or recognized by the intelligence model. When data capable of being used to train the intelligence model is not present, this list is written and included in the profile.

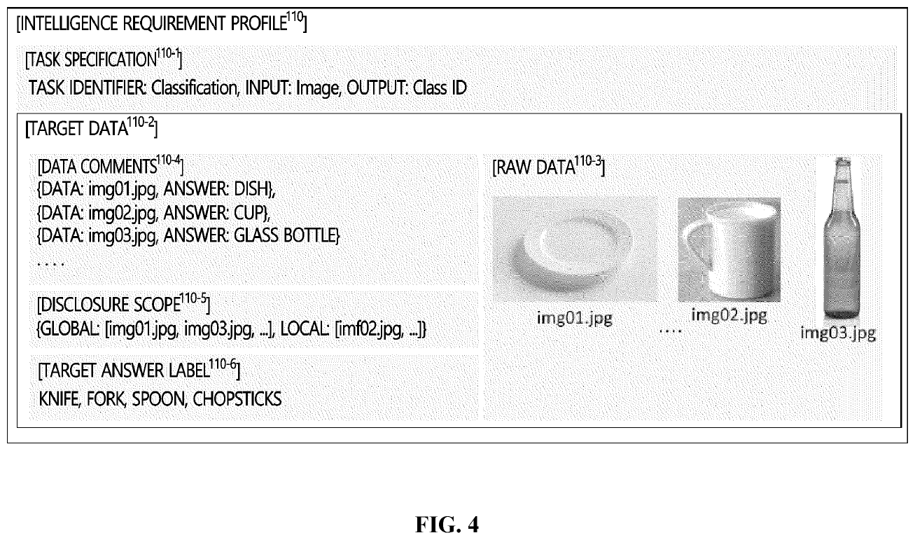

FIG. 4 illustrates an example of an intelligence requirement profile for requesting an intelligence model for image classification.

Referring to FIG. 4, it can be seen that an intelligence model for receiving an image, classifying the same, and outputting a class identifier is requested through a task specification. Target data includes image files capable of being used for training as raw data, and includes answers in classification of the respective image files in data comments. It can be seen that the task specification also includes the disclosure scope for data security.

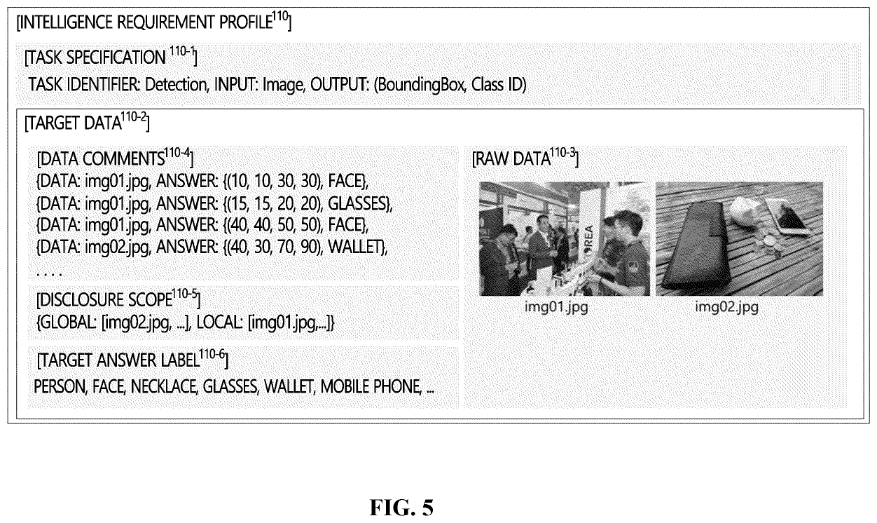

FIG. 5 illustrates an example of an intelligence requirement profile for requesting an intelligence model for an object detection task.

Referring to FIG. 5, it can be seen that an intelligence model for receiving an image, detecting an object, and assigning a class identifier to the area of the detected object is requested through a task specification. Target data includes image files capable of being used for training as raw data, and includes the area of an object included in each of the images and a class corresponding to an answer in data comments.

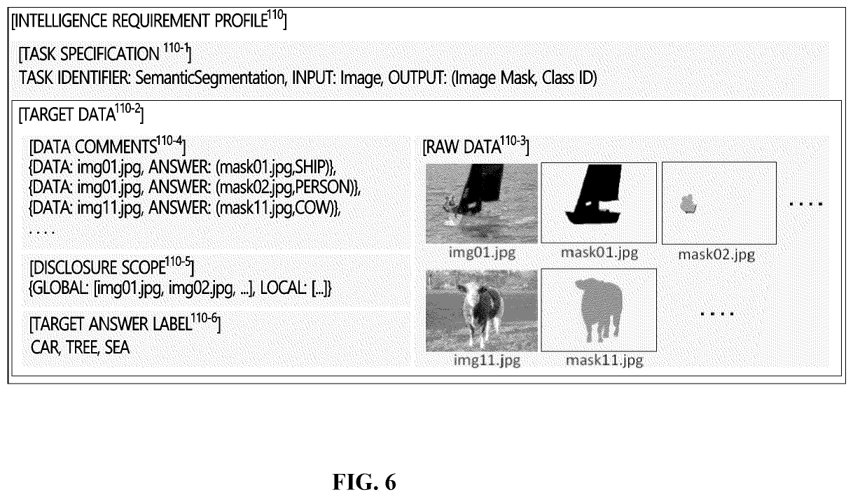

FIG. 6 illustrates an example of an intelligence requirement profile for requesting an intelligence model for a semantics-based image segmentation task.

Referring to FIG. 6, it can be seen that an intelligence model for receiving an image, segmenting an object area in the form of an image mask, and assigning a class identifier to the segmented area is requested through a task specification. Target data includes image files capable of being used for training as raw data, and includes the name of the image to be used as an image mask and a class identifier in data comments. As shown in FIGS. 4 to 6, an intelligence requirement profile may be configured to be suitable for various tasks and then used.

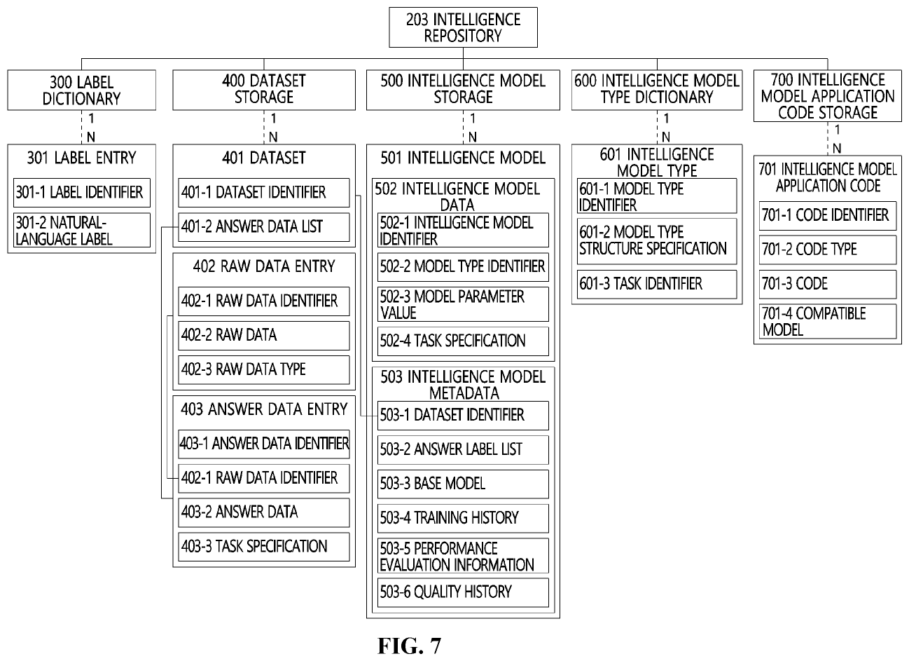

FIG. 7 is a block diagram illustrating the structure of an intelligence repository according to an embodiment of the present invention.

Referring to FIG. 7, an intelligence repository 203 includes a label dictionary 300, dataset storage 400, intelligence model storage 500, an intelligence model type dictionary 600, and intelligence model application code storage 700.

The label dictionary 300 is a dictionary for converting labels, which are written with different character strings or numbers although they have the same meaning, into a standard vocabulary. The standard vocabulary is written using a label identifier 301-1 representing each label.

For example, a global unique identifier, such as a Universally Unique Identifier (UUID), may be used. The content of a label dictionary according to an embodiment is as shown in Table 2 below.

TABLE 2

| Label Identifier | Natural-language label |
|---|---|
| L0000001 | cat, chat |
| L0000002 | dog, chien |
| L0000003 | horse, jument |
| L0000004 | tiger, tigresse |

The label dictionary includes a list of label entries, and each label entry includes a label identifier and a natural-language label. According to the dictionary of Table 2, all of “cat” and “chat” are converted into a standard vocabulary of ‘L0000001’. The label dictionary may be constructed based on a dictionary database such as WordNet, as in the case of ImageNet, and may be extended to various languages using a translator. The method of intelligently constructing and managing the label dictionary is not included in the scope of the present invention.

The dataset storage 400 stores a dataset 401, which is used to train and evaluate an intelligence model, along with raw data entries 402 and answer data entries 403 constituting the dataset.

In an embodiment of the present invention, the dataset is configured with a dataset identifier 401-1 and an answer data list 401-2. The dataset identifier 401-1 is a unique name for uniquely identifying and indicating the dataset. The answer data list 401-2 is a list of answer data identifiers 403-1 indicating the answer data entries 403, and all of the raw data entries 402 and answer data entries 403 constituting the dataset may be read by referring to the answer data list.

The raw data entry 402 includes a raw data identifier 402-1 for uniquely identifying the corresponding entry, raw data 402-2, which is source data to be used to train and evaluate an intelligence model, and a raw data type 402-3 for describing the format of the raw data, such as an image, video, audio, or the like.

The answer data entry 403 includes an answer data identifier 403-1 for uniquely identifying the corresponding entry, a raw data identifier 402-1 for indicating the raw data, which is the target to which the corresponding answer is to be applied, answer data 403-2, which describes the answer label identifier, and a task specification 403-3 for which the corresponding answer is capable of being used.

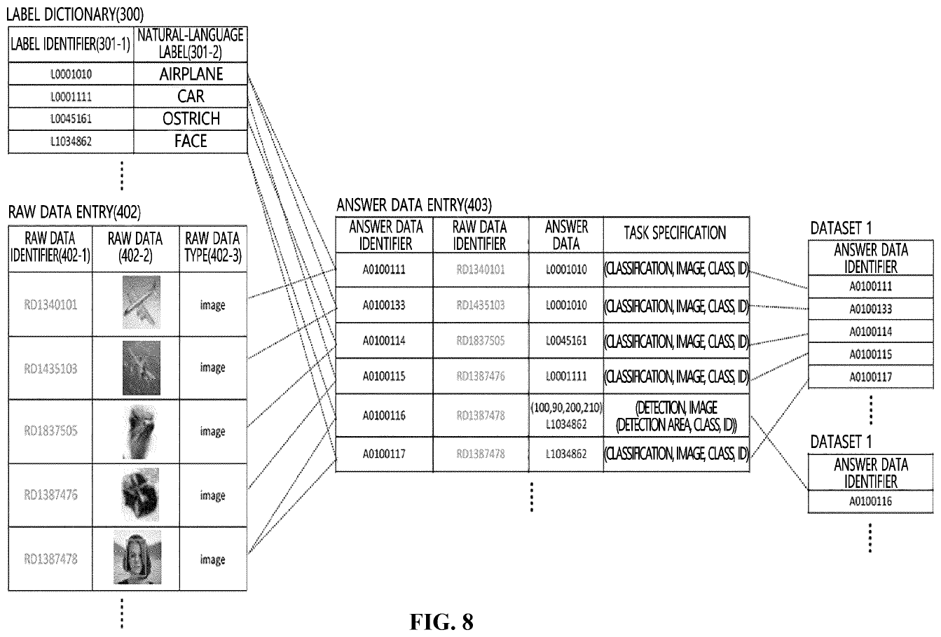

FIG. 8 is a diagram illustrating an example of a dataset in an intelligence model generation method according to an embodiment of the present invention.

Referring to FIG. 8, an answer data entry ‘A0100111’ designates ‘L0001010’ (airplane) as an answer label for the picture indicated by a raw data entry ‘RD1340101’. As shown in the examples of ‘A0100111’ and ‘A0100133’, a single label (L0001010) may be referenced in multiple answer data entries, and the opposite case is also possible. This is because multiple answer labels are capable of being assigned to a single piece of raw data. Multiple answers of different tasks may be assigned to a single piece of raw data. For example, a classification answer, a detection answer, and a segmentation answer may be assigned to a single picture.

In FIG. 8, ‘A0100116’ and ‘A0100117’ respectively assign different answers to a single piece of raw data ‘RD1387478’. ‘A01000117’ is an answer that designates a ‘face (L1034862)’ as the answer label of a classification task in response to a picture including a face, and ‘A0100116’ is an answer for a detection task for detecting a face area included in the picture and classifying the same as a ‘face’. In an embodiment of the present invention, a dataset is configured by describing a list of answer data entries. ‘Dataset 1’ in FIG. 8 is a dataset capable of being used to train and evaluate an intelligence model for receiving an image and classifying the same as one of an airplane, a car, an ostrich, and a face. ‘Dataset 2’ is a dataset capable of being used to train and evaluate an intelligence model for detecting a face in an image.

The intelligence model storage 500 stores multiple intelligence models 501. The intelligence model 501 is configured with a pair of intelligence model data 502 and intelligence model metadata 503.

The intelligence model data 502 is data required for executing the intelligence model. In an embodiment of the present invention, the intelligence model data 502 includes an intelligence model identifier 502-1 for uniquely identifying the model, a model type identifier 502-2 capable of being used to detect the structure of the model, model parameter values 502-3, and a task specification 502-4.

The intelligence model identifier 502-1 is an ID for globally unique identification of the intelligence model, and may be designated using a global identifier, such as a UUID.

The model type identifier 502-2 is a value indicating an intelligence model type 601 for describing the specification of the structure of the model. For example, the model type of an intelligence model based on an AI neural network refers to neural network structure information, which describes how neurons and layers are configured and connected.

The model parameter values 502-3 are the actual values of various parameters of the model. In the case of a neural network model, values such as weights, biases, and the like are included therein. Because there are various methods for describing the model structure and parameter values of an intelligence model based on a neural network and machine learning, these methods may be used to describe intelligence model data. For example, Open Neural Network Exchange (ONNX) is a representative industrial standard for describing a model structure and parameter values.

The task specification 502-4 is information describing the task performed by the intelligence model, and is the same as the task specification 110-1 included in the intelligence requirement profile 110. The task specification 110-1 described in the intelligence requirement profile is compared with the task specification 502-4 included in the intelligence model data 502, whereby an intelligence model capable of appropriately performing the required functions may be selected.

The intelligence model metadata 503 includes description information such as the generation method, functions, and quality of the intelligence model. The intelligence model metadata may be referred to in order to select and use an intelligence model, and may also be used as conditions for filtering out an intelligence model having a quality problem by determining similarity between intelligence models. In an embodiment of the present invention, the intelligence model metadata 503 includes a dataset identifier 503-1, an answer label list 503-2, a base model 503-3, a training history 503-4, performance evaluation information 503-5, and a quality history 503-6.

The dataset identifier 503-1 indicates the dataset that is used to train the intelligence model. The dataset identifier 503-1 has the dataset identifier 401-1 of one of datasets 401 stored in the dataset storage 400 as the value thereof.

The answer label list 503-2 describes a corresponding relationship between the output value of the intelligence model and the label identifier 302. When the intelligence model outputs a class ID, this value is the index of the class. For example, when an intelligence model performs a task for classifying an image into one of two classes corresponding to a dog and a cat, the output value of the intelligence model is 0 or 1. If 0 indicates a cat and 1 indicates a dog, a description of this corresponding relationship is the answer label list 503-2. The corresponding relationship is described by designating a label identifier 301-1 for each class identifier. That is, when the answer label list 503-2 is written as {0:L0000001, 1:L0000002} based on the label dictionary of Table 2, if the output of the intelligence model is 0, this indicates “cat”, having a label identifier of L0000001, and if the output of intelligence model is 1, this indicates “dog”, having a label identifier of L0000002.

The base model 503-3 is the unique identifier of the model that is used to train an intelligence model. For example, if this model is trained through fine-tuning or transfer learning based on model M, the intelligence model identifier 502-1 of M is written in the base model field. When there is no base model, the field is left empty.

The training history 503-4 includes parameter values related to training of an intelligence model and data generated in the training process. For example, not only a learning rate, a batch size, and initial weights of a neural network, but also data input to the neural network and changes in weights in response thereto in every training epoch, changes in parameter values for adjusting the training process, such as a learning rate, and changes in loss are included in the training history.

The performance evaluation information 503-5 is data describing the performance of an intelligence model, and includes the dataset used for evaluation and performance values. The dataset used for evaluation or the unique identifier of an evaluation data entry, the performance values based on the rating scales of the model, and an evaluation environment are described. For example, in the case of an image classification model, unique IDs of all of the pieces of image data used for performance evaluation, performance values, such as classification accuracy, frames per second (fps), and the like, CPU, GPU, and RAM specifications of the system in which the evaluation is performed, and the like may be described. Because the performance values may change depending on the data configuration and the evaluation environment used for the performance evaluation, when different data and environments are used, the evaluation information is continuously added to the performance evaluation information.

The quality history 503-6 includes various kinds of data about problems occurring in the process of applying an intelligence model. For example, a quality history entry may include a unique problem number, problem description information, and information about the severity level of the problem. The severity level may be written as ‘severe’, ‘normal’, ‘negligible, or the like. Each quality history entry includes information such as the user who provided the quality history information, the use time, self-evaluation performance during use, and the like, whereby the reliability of the entry may be improved. The quality history information may be stored in separate quality history storage so as to be shared and tracked by users who use various kinds of intelligence models. The unique number of the information entry stored in the quality history storage is contained in intelligence model metadata, whereby the quality history of the corresponding intelligence model may be referred to.

The intelligence model type dictionary 600 stores intelligence model types 601, which are information structures formally describing the structures of various intelligence models. The intelligence model type 601 includes a model type identifier 601-1, which is used to uniquely identify and indicate the model type, a model type structure specification 601-2, which formally describes the structure of the model, and a task specification 601-3, which describes tasks capable of being processed by the model type.

The model type structure specification 601-2 is an information structure that formally describes an intelligence model, and it should be possible to read the model type structure specification through a program and to generate, train and test an intelligence model based thereon. In an embodiment of the present invention, Open Neural Network Exchange (ONNX), which describes a deep-learning-based intelligence model in a computational graph structure, may be used. This is a method of converting the structure of an intelligence model into the ONNX form and storing the same as the model type structure specification 601-2. A necessary intelligence model type is selected using the model type identifier 601-1, the model type structure specification 601-2 is loaded, and the intelligence model may be trained or tested. Also, the model type structure specification may be used to determine whether different intelligence models have the same structure or similar structures.

The task identifier 601-3 is the same information as the task identifier included in the task specification 502-4 of an intelligence model 501, and describes a task that is capable of being processed by the intelligence model 501 trained based on the corresponding model type 601. For example, when the structure specification 601-2 of a corresponding model type 601 is an AlexNet structure, a classification task may be processed, when it is an R-CNN structure, a detection task may be processed, and when it is a U-Net structure, a segmentation task may be processed.

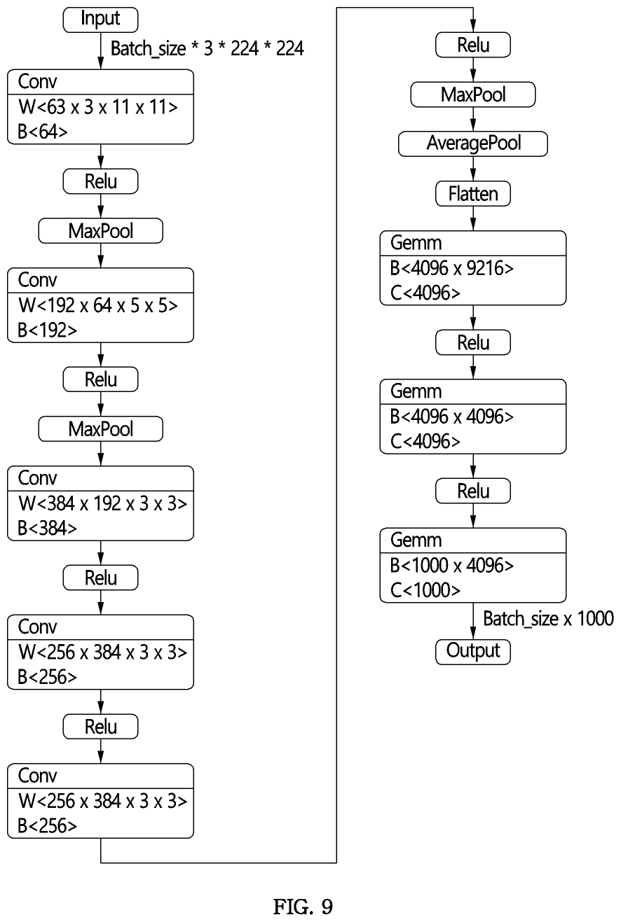

FIG. 9 is a diagram conceptually illustrating an AlexNet structure.

The following Table 3 illustrates that the AlexNet structure of FIG. 9 is converted into an ONNX specification.

TABLE 3
graph torch-jit-export (
%input[FLOAT, batch_sizex3x224x224]
) initializers (
%features.0.weight[FLOAT, 64x3x11x11]
%features.0.bias[FLOAT, 64]
%features.3.weight[FLOAT, 192x64x5x5]
%features.3.bias[FLOAT, 192]
%features.6.weight[FLOAT, 384x192x3x3]
%features.6.bias[FLOAT, 384]
%features.8.weight[FLOAT, 256x384x3x3]
%features.8.bias[FLOAT, 256]
%features.10.weight[FLOAT, 256x256x3x3]
%features.10.bias[FLOAT, 256]
%classifier.1.weight[FLOAT, 4096x9216]
%classifier.1.bias[FLOAT, 4096]
%classifier.4.weight[FLOAT, 4096x4096]
%classifier.4.bias[FLOAT, 4096]
%classifier.6.weight[FLOAT, 1000x4096]
%classifier.6.bias[FLOAT, 1000]
) {
%17 = Conv[dilations = [1, 1], group = 1, kernel_shape = [11, 11], pads = [2, 2, 2, 2], strides = [4,
4]](%input, %features.0.weight, %features.0.bias)
%18 = Relu(%17)
%19 = MaxPool[ceil_mode = 0, kernel_shape = [3, 3], pads = [0, 0, 0, 0], strides = [2, 2]](%18)
%20 = Conv[dilations = [1, 1], group = 1, kernel_shape = [5, 5], pads = [2, 2, 2, 2], strides = [1,
1]](%19, %features.3.weight, %features.3.bias)
%21 = Relu(%20)
%22 = MaxPool[ceil_mode = 0, kernel_shape = [3, 3], pads = [0, 0, 0, 0], strides = [2, 2]](%21)
%23 = Conv[dilations = [1, 1], group = 1, kernel_shape = [3, 3], pads = [1, 1, 1, 1], strides = [1,
1]](%22, %features.6.weight, %features.6.bias)
%24 = Relu(%23)
%25 = Conv[dilations = [1, 1], group = 1, kernel_shape = [3, 3], pads = [1, 1, 1, 1], strides = [1,
1]](%24, %features.8.weight, %features.8.bias)
%26 = Relu(%25)
%27 = Conv[dilations = [1, 1], group = 1, kernel_shape = [3, 3], pads = [1, 1, 1, 1], strides = [1,
1]](%26, %features.10.weight, %features.10.bias)
%28 = Relu(%27)
%29 = MaxPool[ceil_mode = 0, kernel_shape = [3, 3], pads = [0, 0, 0, 0], strides = [2, 2]](%28)
%30 = AveragePool[kernel_shape = [1, 1], strides = [1, 1]](%29)
%31 = Flatten[axis = 1](%30)
%32 = Gemm[alpha = 1, beta = 1, transB = 1](%31, %classifier.1.weight, %classifier.1.bias)
%33 = Relu(%32)
%34 = Gemm[alpha = 1, beta = 1, transB = 1](%33, %classifier.4.weight, %classifier.4.bias)
%35 = Relu(%34)
%output = Gemm[alpha = 1, beta = 1, transB = 1](%35, %classifier.6.weight, %classifier.6.bias)
return %output
}

A method according to an embodiment of the present invention may transform the deep-learning model of FIG. 9 into an ONNX specification and store the same in the intelligence model type dictionary. The stored intelligence model type structure specification may be used later for training and testing after a deep-learning framework model, such as PyTorch or the like, is restored based thereon through a restoration process.

The intelligence model application code storage 700 stores pieces of intelligence model application code 701, which are programs for performing various tasks for an intelligence model. The intelligence model application code 701 includes a code identifier 701-1, which is used to uniquely identify the code, a code type 701-2 for describing the task performed by the code, execution code 701-3, and compatible models 701-4 for recording intelligence models capable of being handled by the code.

In an embodiment of the present invention, the value of the code type 701-2 may be described as inference, training, fine-tuning, knowledge distillation, compression, or the like. Inference-type code performs functions of loading an intelligence model 501, receiving input data, and providing an output value calculated using the intelligence model. Training-type code performs functions of generating an initial intelligence model based on an intelligence model type 601 and training the intelligence model using a dataset 401 or an intelligence requirement profile 110. Fine-tuning-type code performs functions of loading an intelligence model 501, modifying the structure thereof according to the target answer label 110-6 in an intelligence requirement profile 110, and training the intelligence model based on a dataset 401 or target data 110-2.

In an embodiment of the present invention, the code 701-3 uses container runtimes, such as Docker, containerd, and CRI-O, in order to overcome a compatibility problem resulting from different operating environments and to standardize an execution method. For example, Linux OS, CUDA toolkit, Python, or PyTorch framework is installed, after which a Docker container in which code for training an AlexNet model is installed may be stored in the code 701-3 of the intelligence model application code 701 and used. Also, a command script capable of running the container may also be stored in the code 701-3 and used.

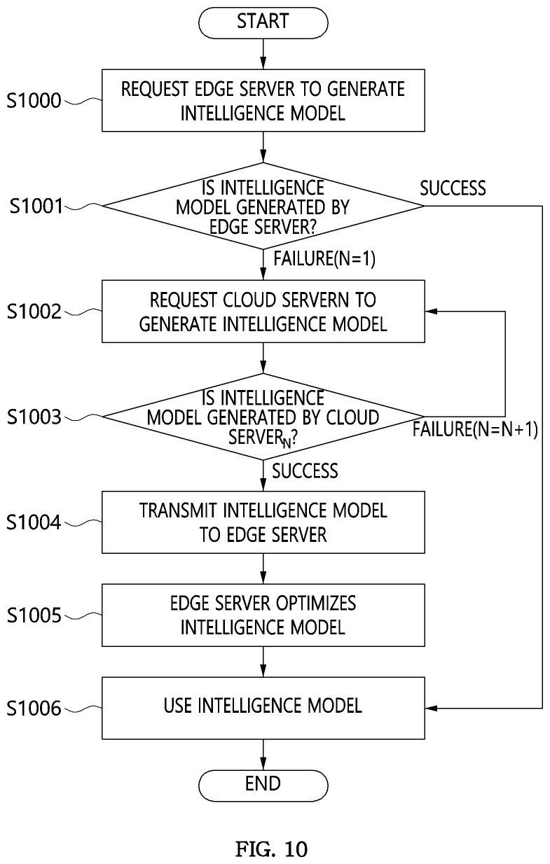

FIG. 10 is a flowchart illustrating an intelligence model distribution process of the present invention.

Referring to FIG. 10, a terminal generates an intelligence requirement profile 110, including a task to be performed by an intelligence model and training data, and requests an edge server to generate and distribute an intelligence model at step S1000.

That is, step S1000 is a step in which the terminal requests an intelligence model required for providing an intelligence service. A person involved in provision of an intelligence service, such as the manufacturer of the terminal, an installation expert, a user, or the like, generates an intelligence requirement profile 110 using an arbitrary user interface (capable of being provided by all of the terminal, an edge server, and a cloud server). The user interface may be provided in any of various forms, such as a web interface, a graphical user interface, a chatbot, a command window, and the like.

The intelligence manager of the terminal requests distribution of an intelligence model by transmitting the intelligence requirement profile 110 to the edge server 150. The structure and content of the intelligence requirement profile are as shown in the examples of FIGS. 3 to 5.

The intelligence manager 201 of the edge server generates a new intelligence model at step S1001 by selecting a ‘base intelligence model’, constructing a dataset for training/testing', and performing training based on the task specification and the data included in the received intelligence requirement profile 110 while referring to an intelligence repository 203 through an intelligence repository interface 204. When generation of the intelligence model succeeds, the generated intelligence model and the dataset information are added and registered in the intelligence repository 203. The intelligence manager 201 transfers the generated intelligence model and a program for running the intelligence model to the terminal, and the terminal uses the intelligence model.

When the intelligence manager 201 of the edge server fails to generate an intelligence model at step S1001, the intelligence manager 201 modifies the intelligence requirement profile 110 based on rules defined according to purposes such as data security or the like and transmits the modified intelligence requirement profile to a cloud server, thereby requesting generation and distribution of an intelligence model at step S1002.

The intelligence manager 201 of the cloud server attempts to generate an intelligence model at step S1003 using the same method as the method performed by the intelligence manager 201 of the edge server. When generation of an intelligence model succeeds, the generated intelligence model and a dataset related thereto are registered in the intelligence repository 203. When generation of an intelligence model fails, the intelligence requirement profile 110 is forwarded to a cloud server at the next tier, whereby generation and distribution of an intelligence model is requested at step S1002.

When it succeeds in generation of an intelligence model, the intelligence manager 201 of the cloud server transmits the intelligence model and a program for running the intelligence model to the edge server that requested distribution at step S1004.

When there is data separately stored in the process of modifying the intelligence requirement profile 110, the edge server optimizes the intelligence model using the data. The optimized intelligence model is added and registered in the intelligence repository 203 of the edge server, and the intelligence model and the program for running the intelligence model are transmitted to the terminal at step S1005. The terminal uses the received intelligence model and the program for running the intelligence model at step S1006.

Steps S1001 and S1003 of FIG. 10 include a process of generating an intelligence model based on the intelligence requirement profile 110. Below, a process of generating an intelligence model for performing a classification task by an embodiment of the present invention will be described in detail.

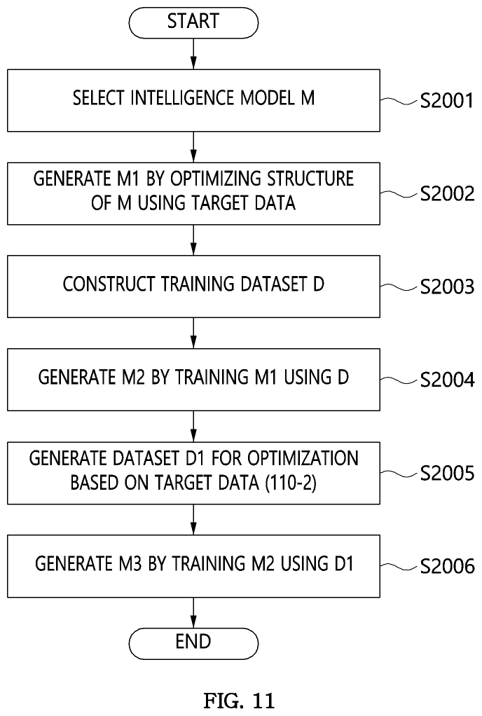

FIG. 11 is a flowchart illustrating a process of generating an intelligence model according to an embodiment of the present invention.

Referring to FIG. 11, an intelligence manager 201 selects a compatible intelligence model M at step S2001 by searching an intelligence repository 203 based on a task specification 110-1 and target data 110-2 in order to generate an intelligence model capable of performing the task specified in an intelligence requirement profile 110.

In an embodiment of the present invention, selecting a compatible intelligence model follows a method of comparing the task specification 110-1 specified in the intelligence requirement profile 110 with the task specification 502-4 of an intelligence model 501 stored in intelligence model storage 500 and selecting the intelligence model when the two task specifications are the same as each other. This is called a first selection process.

When two or more intelligence models are selected in the first selection, a second selection process is performed based on the target data 110-2 of the intelligence requirement profile 110. In an embodiment of the present invention, this process is performed by calculating the similarity between a standard target label list and the answer label list 503-2 of the compatible intelligence model.

The standard target label list is the result of combining the answers in the target data 110-2 and the answer labels included in the target answer label list 110-6 and converting each of the labels into a standard vocabulary using a vocabulary interpreter 201-2. The vocabulary interpreter 201-2 refers to a label dictionary 300 for vocabulary conversion. Failure of vocabulary interpretation is regarded as failure of generation of an intelligence model.

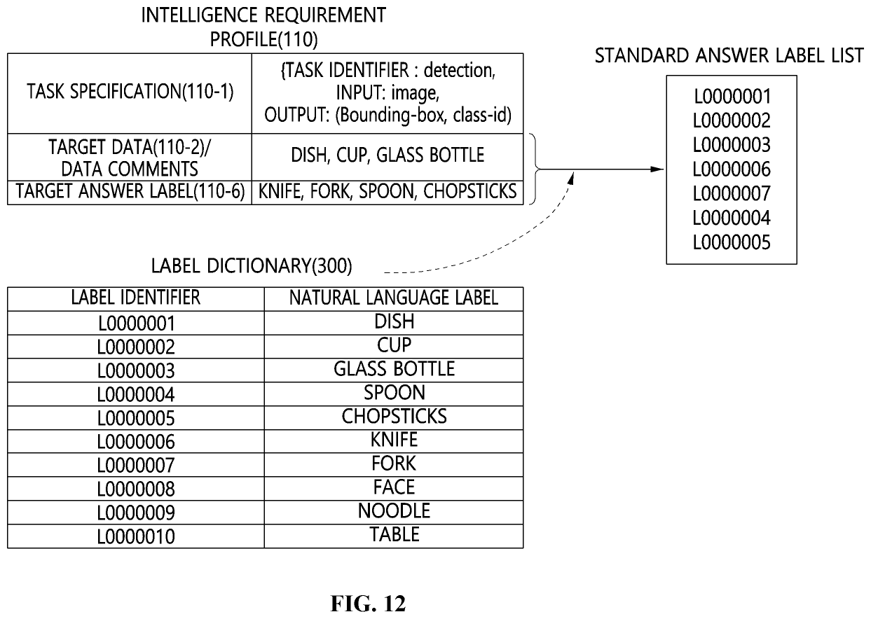

FIG. 12 is an example of generation of a standard answer label list.

The similarity between a standard target label list and the answer label list 2000-2 of a compatible intelligence model may be calculated using various methods. In an embodiment of the present invention, the similarity of the two label lists may be calculated using a Jaccard index. The higher the similarity between the two label lists, the higher the priority with which the intelligence model is selected.

When two or more intelligence model have the same priority after the second selection process, a third selection process for selecting a model having excellent performance and having no quality problem is performed. In an embodiment of the present invention, the third selection process is performed based on the intelligence mode metadata 503 of the intelligence repository 203. As explained in the following example, a method of referring to general performance and a quality index or measuring performance with respect to the target data may be used.

In the method of referring to general performance, the best intelligence model is selected by comparing the performance evaluation information 503-5 specified in the intelligence model data 503.

In the method of referring to the quality index, an intelligence model having no quality problem is selected by comparing information about the quality history 503-6 specified in the intelligence model metadata 503.

In the method of measuring performance with respect to the target data, the performance of the intelligence model is evaluated with respect to the target data 110-2 included in the intelligence requirement profile, whereby the intelligence model having the highest performance is selected. To this end, intelligence model application code 701 capable of performing an inference task for the model type 601 of the target intelligence model to be evaluated is selected from intelligence model application code storage 700, after which the inference function is performed for the target data 110-2 through the candidate intelligence model 501, whereby a task of evaluating performance may be performed.

Here, in order to select a more suitable intelligence model, adjustment may be performed by varying weights for performance with respect to the target data, general performance, and the quality index depending on the intelligence model application situation and environment.

Through the three selection process steps, intelligence model M having the highest priority is selected. When M is selected, application code for performing various functions for M is read and acquired. Specifically, intelligence model application code 701, including the model type 502-2 of M in the compatible model 701-4, is selected from the intelligence model application code storage 700, whereby the code is acquired. In an embodiment of the present invention, each piece of code is configured as a pair including a container and a script for running the container, and may be used to perform functions such as inference, training, fine-tuning, knowledge distillation, and the like. That is, after intelligence model M is selected, code C1 for performing an inference function by receiving intelligence model M, code C2 for performing a training function, code C3 for performing a fine-tuning function, and the like are secured.

Subsequently, when the answer label list capable of being processed by M does not exactly match the standard target answer label list, the structure of intelligence model M is modified, whereby M1 is generated at step S2002.

For example, when M is an intelligence model for classifying an image as one of 100 classes and when the standard target label list includes only ten answers, M is optimized such that it is capable of classifying an image as one of only the ten classes included in the standard target label list, and this is the purpose of this step.

If M has a convolutional neural network structure for a classification task, the number of nodes in the final classification layer is 100, and the nodes may be connected with a convolutional layer having a fully-connected structure. At this step, the classification layer of M, including 100 output nodes, is removed, and a classification layer including ten output nodes is generated and connected.

In an embodiment of the present invention, when M1 is generated, output nodes may be generated such that the number thereof is one more than the number of standard target answer labels. The added node is a node representing ‘unknown’, and training is performed so as to activate the node when data that does not correspond to any of the standard target answer labels is input to the intelligence model, whereby a false-positive probability may be decreased and class classification accuracy may be improved.

It is unnecessary to perform this step (S2002) when the length of the answer label list of M is equal to the length of the standard target label list.

Subsequently, dataset D with which M1 is to be trained is configured at step S2003. D is constructed by reading the dataset storage 400 of the intelligence repository 203 based on the standard target label list. First, the data entries 402 and 403 of labels included in the standard target label list are collected by reading the dataset 401, which was used to train M, using the identifier 503-1, whereby D is constructed. If there is a label for which data is not secured using this method, among the standard target labels, data entries, the answer data 403-2 of which is the same as the standard target label, are retrieved from the dataset storage 400 and added to D. After D is configured, table L for mapping each label of the standard target label list to a class index is also constructed.

Various concerns that have to be considered for training of M, such as standardizing the number of pieces of data for each class, determining the number of pieces of data for each class so as to be suitable for the size of M, segmenting D into training data, validation data, and test data, and the like, are considered to perform this step.

When an ‘unknown’ node is generated at step S2002, labels that are not included in the standard target labels are randomly selected, and data corresponding thereto is selected and assigned to an ‘unknown’ class, whereby dataset D is configured. Training is performed such that data other than data included in the class corresponding to the standard target labels is included in the ‘unknown’ class, whereby a false positive probability may be decreased and the accuracy of classification by the intelligence model may be improved.

Subsequently, M2 is generated by training M1 using D at step S2004. Any of various training methods may be applied depending on the type of an intelligence model, and as described above, pieces of code therefor are secured using the intelligence model application code storage 700 of the intelligence repository 203. The task in this step may be performed by inputting D and M1 to the secured ‘training’ code and running the code.

Here, M2 and D are registered in the intelligence repository 203. The intelligence model data 502 and the intelligence model metadata 503 of M2 must be appropriately specified. An intelligence model identifier 502-1 is newly generated and registered, and model parameter values 502-3, an answer label list 503-2, a training history 503-4, and performance evaluation information 503-5 have to be recorded with suitable information. The dataset identifier 402-1 of D is recorded in the dataset identifier 503-1. The intelligence model identifier 502-1 of M is recorded in the base model 503-3. D is recorded by registering the new dataset identifier 401-1 and storing the answer data list 401-2 constituting D.

By performing steps S2002 to S2004, effects of reducing the size of an intelligence model and improving the accuracy of the intelligence model may be obtained.

Subsequently, dataset D1 to be used to optimize M2 for the intelligence requirement is configured based on the target data included in the intelligence requirement profile 110 at step S2005. D1 is configured with pairs, each including a data entry included in raw data 110-3 and a data comment 110-4 corresponding to the entry. An answer in the data comment is converted into a standard vocabulary using a label dictionary 300, the class index thereof is acquired using table L constructed at step S2003, and the result is taken as the answer for each piece of raw data.

Subsequently, M3 is generated by training M2 using D1 at step S2006. Like step S2004, this step may be performed by inputting D1 and M2 to the ‘training’ code acquired from the intelligence model application code storage 700 and running the code.

M3 and D1 are registered in the intelligence repository 203. Here, it is necessary to suitably write the intelligence model data 502 and the intelligence model metadata 503 of M3. An intelligence model identifier 502-1 is newly generated and registered, and model parameter values 502-3, an answer label list 503-2, a training history 503-4, and performance evaluation information 503-5 have to be recorded with suitable information. The dataset identifier 402-1 of D1 is recorded in the dataset identifier 503-1. The intelligence model identifier 502-1 of M2 is recorded in the base model 503-3. D1 is recorded by registering the new dataset identifier 401-1 and storing the answer data list 401-2 constituting D1.

An intelligence model satisfying the task specification specified in the intelligence requirement profile may not be found in the intelligence model storage in the first selection process at step S2001. Here, the intelligence manager 201 may select and use an intelligence model type, the task identifier 601-3 of which is the same as the task identifier of the task specification 110-1, among the intelligence model types 601 stored in the intelligence model type dictionary 600. After the intelligence model type 601 is selected, the model type structure specification 601-2 is restored, whereby an initial model BM having null values as the model parameter values thereof is generated. Then, BM may be used instead of M. Because BM is an empty model that is not trained, a model capable of performing its own functions may be generated only after step S2004 is performed. The subsequent process is the same as the above-described process.

Hereinafter, a method for modifying an intelligence requirement profile for data security will be described in detail.

When the edge server 150 fails to generate an intelligence model at step S1001, it transmits the intelligence requirement profile to a cloud server and entrusts the cloud server with the task of generating an intelligence model. Here, the intelligence manager 201 of the edge server 150 modifies the intelligence requirement profile in consideration of the data disclosure scope and transmits the modified intelligence requirement profile to the cloud server, thereby performing a data protection function.

For example, in the intelligence requirement profile of FIG. 4, the disclosure scope is specified as ‘local’ or ‘global’. In this case, a rule is applied such that the edge server is not allowed to transmit the data, the disclosure scope of which is limited to ‘local’, to the cloud server, whereby data of a customer, the owner of the edge server, or the service operator may be protected. The intelligence requirement profile transmitted to the cloud server by the edge server includes 1) all target data, the disclosure scope of which is set to ‘global’, 2) answer labels for the target data, the disclosure scope of which is set to ‘local’, and 3) a target answer label list. The edge server stores and preserves the target data, the disclosure scope of which is set to ‘local’, for local optimization of the intelligence model.

In another embodiment, the disclosure scope may be set to multiple levels. As shown in FIG. 3, intermediate servers may be arranged across multiple tiers between the terminal and the final cloud server, in which case the disclosure scope may be defined and described in detail so as to specify the tier in which the server to which data is allowed to be transmitted is located. In a further embodiment, the disclosure scope may be set automatically. For example, a detector capable of determining whether a person is present in a picture or video is installed, detection is performed for raw data included in the intelligence requirement profile, and the disclosure scope of all pieces of data including a person may be set to ‘local’. As described above, the entity managing or using the system according to the present invention may set the disclosure scope by specifying specific objects, and may make the edge server automatically process the data security function.

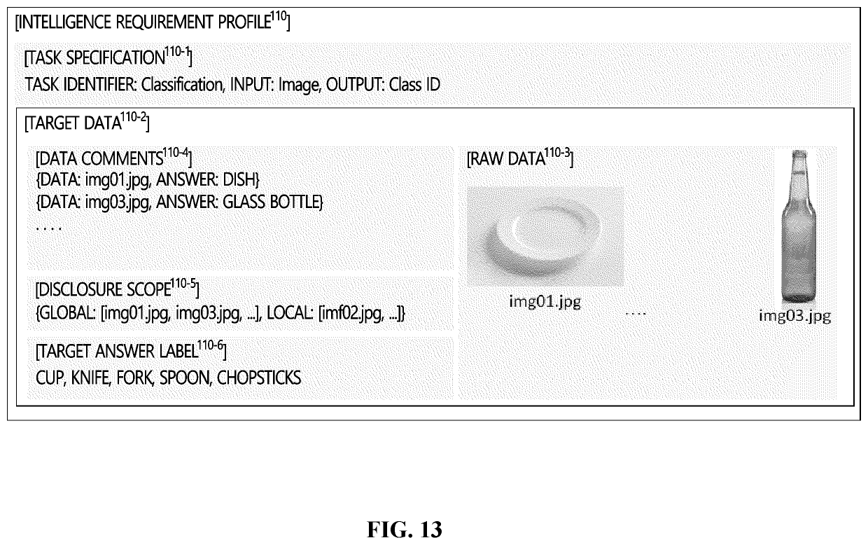

FIG. 13 is an example of the result of modifying, by an edge server, the intelligence requirement profile of FIG. 4 based on the data disclosure scope.

Data related to img02.jpg, the disclosure scope of which is set to ‘local’, is deleted from the intelligence requirement profile, and ‘cup’, which is the answer label for img02.jpg, is added to target answer labels. This is because raw data corresponding to ‘cup’ is not present in the profile. In this example, because there is no need to transmit the disclosure scope field to a cloud server, this field is deleted from the intelligence requirement profile.

Hereinafter, a method for optimizing an intelligence model in an edge server will be described in detail.

At step S1002, the edge server removes raw data 110-3, the disclosure scope of which is set to ‘local’, and the data comment 110-4 thereof from the intelligence requirement profile 110 and stores the same therein. Based on the data entries stored in the edge server, dataset D2 is configured. D2 is configured with a pair including a raw data entry and an answer in the data comment thereof.

The edge server 150 receives intelligence model M3 and trains the same using D2, thereby generating a final intelligence model M4 requested based on the intelligence requirement profile 110. The training method is the same as that used at steps S2004 and S2006. Thereby, data that is not used to optimize the intelligence model in the cloud server due to the limited disclosure scope thereof may be applied for optimization of the performance of the intelligence model.

D2 and M4 are also registered in the intelligence repository 203 in the same manner as the manner of registering D, D1, M2 and M3.

Hereinafter, the method of managing the quality of an intelligence model will be described in detail.

Information about the quality history 503-6 included in intelligence model metadata 503 may be used as reference data for selecting a high-quality intelligence model having no history of problems. When an intelligence model has significantly low quality or entails a severe risk, the intelligence model may be prevented from being used for important tasks.

For example, when model M causes a problem due to an error occurring in a specific situation, information describing the situation is transmitted to an edge server or a cloud server through an intelligence repository interface 204. When the information is transmitted, the edge server and the cloud server add the information to the quality history field 503-6 in the intelligence model metadata of model M. In the future, the quality of the intelligence model may be predicted by reading this field. If a certain intelligence model M causes significant performance degradation or causes a problem in a specific situation, a model that is the same as or similar to M is retrieved, whereby an intelligence model having the possibility of causing a problem may be selected.

The model that is the same as M may be found by comparing the intelligence model identifier 502-1 included in intelligence model data 502 with that of M.

In an embodiment of the present invention, a model that is similar to M may be found using the following method.

1) The base model 503-3 specified in the intelligence model metadata 503 of M is the intelligence model that was used to generate M, so it is determined to be a model similar to M. The base model of M may be generated from another base model. In this way, the base model of the intelligence model is successively tracked, whereby models similar to M may be found.

2) A similar model may be found by measuring the similarity between the intelligence model data thereof and that of M. The model types 502-2, the training datasets 503-1, the answer label lists 503-2, the base models 503-3, the training histories 503-4, and the like of the two intelligence models are compared with each other, and as the two models are more similar, they may be determined to be similar models.

Although the similarity between the pieces of data does not necessarily prove the similarity of the operation characteristics of the two models, it may be used to predict the likelihood of causing a problem.

Hereinafter, the configuration of an intelligence repository and content stored therein will be described in detail with reference to Tables 4 to 8 below.

Table 4 illustrates an embodiment of an intelligence requirement profile 110.

Table 5 illustrates an embodiment of a label dictionary 300.

Table 6 illustrates an embodiment of an intelligence model type dictionary 600.

Table 7 illustrates an embodiment of intelligence model storage 500.

Table 8 illustrates an embodiment of intelligence model application code storage 700.

TABLE 4

| | |
|---|---|
| Task specification (110-1) | {task identifier: detection, |
| | input: image, |
| | output: (Bounding-box, class-id)} |
| target data (110-2)/data | plate, cup, glass bottle |
| comment(110-4) | |
| target answer label (110-6) | knife, fork, spoon, chopsticks |

TABLE 5

| label identifier | natural-language label |
|---|---|
| L0000001 | plate |
| L0000002 | cup |
| L0000003 | glass bottle |
| L0000004 | spoon |
| L0000005 | chopsticks |
| L0000006 | knife |
| L0000007 | fork |
| L0000008 | face |
| L0000009 | noodle |
| L0000010 | table |

TABLE 6

| | model type structure | |
|---|---|---|
| model type identifier | specification | task identifier |
| (601-1) | (601-2) | (601-3) |
| IMT00003 | alexnet01.onnx | classification |
| IMT00002 | yolo4_003.onnx | detection |
| IMT00005 | resnet078.onnx | classification |

TABLE 7

| | | | |
|---|---|---|---|
| intelligence model | IM000009 | IM000011 | IM000015 |
| identifier (502-1) | | | |
| model type identifier (502-2) | IMT00003 | IMT00002 | IMT00005 |
| model parameter value (502-3) | Im000009.onnx | Im000011.onnx | Im000015.onnx |
| task specification (502-4) | {task identifier: | {task identifier: detection, | {task identifier: |
| | classification, | input: image, | classification, |
| | input: image, | output: (Bounding-box, | input: image, |
| | output: class-id} | class-id)} | output: class-id} |
| dataset identifier (503-1) | DS000001 | DS000004 | DS000008 |
| answer label list (503-2) | {0: L0000001, 1: L0000002, | {0: L0000001, 1: L0000002, | {0: L0000001, 1: L0000002, |
| | 2: L0000003, 3: L0000004, | 2: L0000003, 3: L0000004, | 2: L0000003, 3: L0000004, |
| | 4: L0000005, 5: L0000006, | 4: L0000008, 5: L0000009} | 4: L0000005, 5: L0000006, |
| | 6: L0000007, 7: L0000008, | | 6: L0000007} |
| | 8: L0000009, 9: L0000010} | | |
| base model (503-3) | IM000003 | IM000003 | IM000003 |
| training history (503-4) | {epoch: 100, | {epoch: 100, | {epoch: 100, |
| | batch-size: 4096, | batch-size: 4096, | batch-size: 4096, |
| | learning rate: 0.01, | learning rate: 0.01, | learning rate: 0.01, |
| | drop-out: 0.1} | drop-out: 0.1} | drop-out: 0.1} |
| performance evaluation | {dataset: DS000001, | {dataset: DS000001, | {dataset: DS000001, |
| information (503-5) | recall: 0.992, | mAP: 0.67} | recall: 0.96, |
| | precision: 0.87} | | precision: 0.89} |
| quality history (503-6) | [{2021 Jul. 3, severe, | { } | { } |
| | http://imhist.org/283940548}] | | |

TABLE 8

| code | | | compatible |
|---|---|---|---|
| identifier | code type | code | model |
| (701-1) | (701-2) | (701-3) | (701-4) |
| CD000001 | inference | {imcloud/imt00003: inference, | IM000009 |
| | | script001.bash} | |
| CD000002 | training | {imcloud/imt00003: training, | IM000009 |
| | | script002.bash} | |
| CD000003 | inference | {imcloud/imt00002: inference, | IM000011 |
| | | script003.bash} | |
| CD000004 | training | {imcloud/imt00002: training, | IM000011 |
| | | script004.bash} | |

It can be seen that the intelligence requirement profile 110 of Table 4 requests an intelligence model capable of detecting seven object classes by receiving an image as input.

In order to select an intelligence model satisfying such a request, the task specification 110-1 of the intelligence requirement profile is compared with the task specification 502-4 of each intelligence model in the intelligence model storage 500, whereby an intelligence model having the same task specification is selected. Referring to Table 7, it can be seen that IM000011 satisfies the corresponding condition.

Referring to the intelligence model type identifier 502-2 of the intelligence model IM000009, it can be seen that the model structure is IMT00003, and referring to the intelligence model type dictionary 600, it can be seen that the structure specification of this model is formally specified in alexnet01.onnx, and is capable of being used for a classification task. The specification ‘alexnet01.onnx’ is an ONNX structure, and when a compatible deep-learning framework is used, an initial intelligence model before training, which is built to have the corresponding model structure acquired through restoration, may be generated and used.

Referring to the training history 503-4 of IM000009, the set values of various parameters used for training, such as an epoch, a batch size, a learning rate, and the like, may be read.

Referring to the performance evaluation information 503-5 of IM000009, it can be seen that recall performance of 0.992 and precision performance of 0.87 are achieved with respect to dataset DS000001. It can be seen that IM000015 achieves recall performance of 0.96 and precision performance of 0.89 for the same dataset. The values of the same type of performance are compared with each other for the intelligence models having the same task specification, whereby the performance of the intelligence models may be compared.

Referring to the quality history 503-6 of IM000009, there is a history reported on 2021-07-03, the state is severe, and the URL of relevant information is written. Through this, the fact that the corresponding intelligence model caused a severe problem may be detected.

In the intelligence model application code storage 700, there are code CD000001 capable of performing inference for model IM000009 and code CD000002 capable of performing training therefor, and it can be seen that they are implemented as containers and that the identifier (e.g., imcloud/imt00003:inference) thereof and a script for running the container (e.g., script001.bash) are stored therein. The corresponding code may be used when model IM00009 is employed to generate, optimize, and apply an intelligence model.

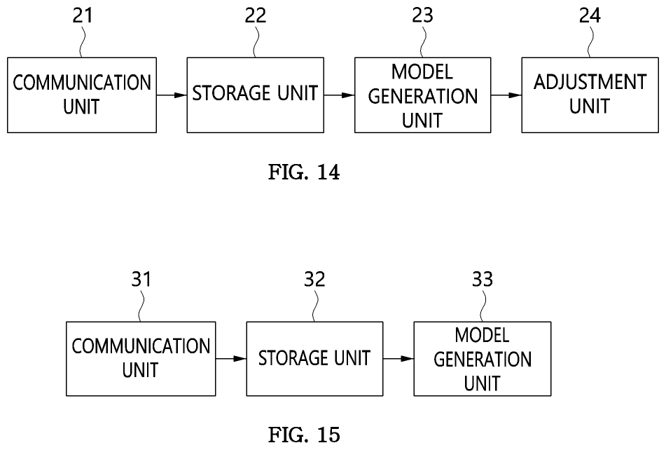

FIG. 14 is a block diagram illustrating the structure of an edge server according to an embodiment of the present invention.

Referring to FIG. 14, the edge server according to an embodiment of the present invention includes a communication unit 21 for communicating with a user terminal and another server, a storage unit 22 in which data for generating an intelligence model is stored, a model generation unit 23 for generating an intelligence model corresponding to an intelligence model generation request, and an adjustment unit 24 for adjusting the generated intelligence model.

Here, when the model generation unit fails to generate the intelligence model, the communication unit 21 may request a cloud server to generate an intelligence model and receive the intelligence model generated by the cloud server.

Here, the cloud server may include a first cloud server and a second cloud server having a greater capacity than the first cloud server.

Here, when it fails to generate an intelligence model, the first cloud server may request the second cloud server to generate an intelligence model.

Here, the request to generate an intelligence model may include a task identifier, raw data, a comment, a data disclosure scope, and a target label.

Here, the model generation unit 23 may select a basic intelligence model based on the intelligence model generation request, modify the label list of the basic intelligence model so as to correspond to the target label list, and train the modified intelligence model.

Here, the communication unit 21 may transmit the raw data to the cloud server based on the data disclosure scope.

Here, the adjustment unit 24 may adjust the intelligence model using the raw data that is not transmitted to the cloud server.

FIG. 15 is a block diagram illustrating the structure of a cloud server according to an embodiment of the present invention.

Referring to FIG. 15, a cloud server according to an embodiment of the present invention may include a communication unit 31 for receiving a intelligence model generation request from an edge server, a storage unit 32 in which data for generating an intelligence model is stored, and a model generation unit 33 for generating an intelligence model corresponding to the intelligence model generation request, and the intelligence model generation request may include a task identifier, raw data, a comment, a data disclosure scope, and a target label.

Here, when the model generation unit fails to generate an intelligence model, the communication unit 31 may request another cloud server to generate an intelligence model.

Here, the raw data included in the intelligence model generation request may be transmitted from the edge server based on the data disclosure scope.

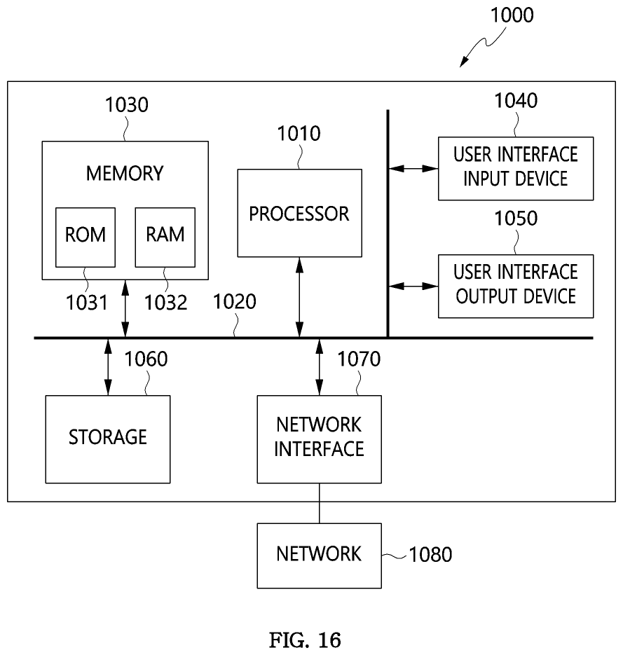

FIG. 16 is a diagram illustrating the configuration of a computer system according to an embodiment.

The edge server and the cloud server according to an embodiment may be implemented in a computer system 1000 including a computer-readable recording medium.

The computer system 1000 may include one or more processors 1010, memory 1030, a user interface input device 1040, a user interface output device 1050, and storage 1060, which communicate with each other through a bus 1020. The computer system 1000 may further include a network interface 1070 connected to a network 1080. Each processor 1010 may be a Central Processing Unit (CPU) or a semiconductor device for executing programs or processing instructions stored in the memory 1030 or the storage 1060. Each of the memory 1030 and the storage 1060 may be a storage medium including at least one of a volatile medium, a nonvolatile medium, a removable medium, a non-removable medium, a communication medium, and an information delivery medium. For example, the memory 1030 may include Read-Only Memory (ROM) 1031 or Random Access Memory (RAM) 1032.

According to the present invention, a method for generating and distributing an intelligence model through a complex computing environment configured with a cloud server and an edge server may be provided.

Also, the present invention enables an intelligence model optimized for an application to be quickly secured at low cost.

Also, the present invention enables an intelligence model optimized for an application service and environment to be generated even when there is no data or there is only a small amount of data.

Also, the present invention prevents data from being exposed outside by dualizing an intelligence model generation process, thereby preventing a security problem and a privacy invasion problem.

Specific implementations described in the present invention are embodiments, and are not intended to limit the scope of the present invention. For conciseness of the specification, descriptions of conventional electronic components, control systems, software, and other functional aspects may be omitted. Also, lines connecting components or connecting members illustrated in the drawings show functional connections and/or physical or circuit connections, and may be represented as various functional connections, physical connections, or circuit connections that are capable of replacing or being added to an actual device. Also, unless specific terms, such as “essential”, “important”, or the like, are used, the corresponding components may not be absolutely necessary.

Accordingly, the spirit of the present invention should not be construed as being limited to the above-described embodiments, and the entire scope of the appended claims and their equivalents should be understood as defining the scope and spirit of the present invention.

1.-20. (canceled)

21. An intermediate server comprising:
a communication unit for performing communication with a user terminal or an upper-level server;
a storage unit for storing data for generating an intelligence model;
a model generation unit for generating an intelligence model based on an intelligence requirement profile; and
an adjustment unit for adjusting the generated intelligence model,
wherein the intelligence requirement profile includes a task specification corresponding to an intelligence model generation request and target data used to train the intelligence model.

22. The intermediate server of claim 21, wherein the target data includes raw data and a data disclosure scope corresponding to the raw data.

23. The intermediate server of claim 22, wherein the model generation unit divides the raw data into public raw data to be transmitted to at least one upper-level server and private raw data not to be transmitted to the upper-level server using the data disclosure scope.

24. The intermediate server of claim 23, wherein the model generation unit is configured to:
delete the private raw data and a data comment corresponding to the private raw data from the intelligence requirement profile,
generate a modified intelligence requirement profile by adding a target answer label corresponding to the data comment, and
transmit the modified intelligence requirement profile to the upper-level server.

25. The intermediate server of claim 24, wherein the model generation unit receives the generated intelligence model based on the modified intelligence requirement profile from the upper-level server, and the adjustment unit adjusts the generated intelligence model using the private raw data.

26. The intermediate server of claim 21, wherein the model generation unit is configured to:
select a basic intelligence model, among intelligence models stored in the storage unit, based on the intelligence requirement profile, and
generate the intelligence model based on the basic intelligence model.

27. The intermediate server of claim 26, wherein the basic intelligence model is selected using similarity between a label list of the basic intelligence model and a target label list included in the intelligence requirement profile.

28. The intermediate server of claim 26, wherein the model generation unit is configured to:
modify the label list of the basic intelligence model to correspond to the target label list, and
perform training of a modified intelligence model.

29. The intermediate server of claim 28, wherein the training of a modified intelligence model comprises:
first training using a previously stored dataset, and
second training using raw data included in the intelligence requirement profile.

30. The intermediate server of claim 29, wherein the previously stored dataset is generated by selecting data corresponding to the target label list from the storage unit.

31. A method for generating an intelligence model, the method being performed by a server and comprising:
receiving an intelligence model generation request from a user terminal;
generating an intelligence model corresponding to an intelligence requirement profile; and
adjusting the generated intelligence model,
wherein the intelligence requirement profile includes a task specification corresponding to an intelligence model generation request and target data used to train the intelligence model.

32. The method of claim 31, wherein generating the intelligence model comprises:
selecting a basic intelligence model, among intelligence models stored in the storage unit, based on the intelligence requirement profile;
generating the intelligence model based on the basic intelligence model.

33. The method of claim 32, the basic intelligence model is selected using similarity between a label list of the basic intelligence model and a target label list included in the intelligence requirement profile.

34. The method of claim 32, wherein the storage unit stored intelligence model metadata corresponding to each intelligence model in the storage unit, and the intelligence model metadata includes a training history, performance evaluation information or a quality history.

35. The method of claim 34, wherein the training history includes changes in parameter values for training, the performance evaluation information includes dataset used for evaluation and performance values, and the quality history includes data about problems occurring in the process of applying an intelligence model.

36. The method of claim 34, wherein generating the intelligence model comprises selecting the basic intelligence model, among the intelligence models stored in the storage unit, based on the intelligence model metadata.

37. A method for utilizing an intelligence model, the method being performed by a user terminal and comprising:
requesting a server to generate an intelligence model corresponding to an intelligence requirement profile;
receiving the intelligence model; and
performing a service using the intelligence model,
wherein the intelligence requirement profile includes a task specification corresponding to an intelligence model generation request and target data used to train the intelligence model.

38. The method of claim 37, wherein the target data includes raw data and a data disclosure scope corresponding to the raw data.

39. The method of claim 38, wherein the data disclosure scope represents whether the raw data can be transmitted to the upper-level server.

40. The method of claim 39, wherein the intelligence model is adjusted by using private raw data not transmitted to the upper-level server.
